(19) United States
(12) Patent Application Publication
(10) Pub. No.: US 2019/0313687 A1
(43) Pub. Date: Oct. 17, 2019

(54) ICE CANDY FORMING TOOL FOR PETS

(71) Applicant: DoggyMan H. A. Co., Ltd., Osaka (JP)

(72) Inventors: Akio Hayashi, Osaka-shi (JP); Masashi Oki, Osaka-shi (JP)

(73) Assignee: DoggyMan H. A. Co., Ltd., Osaka (JP)

(21) Appl. No.: 16/059,441

(22) Filed: Aug. 9, 2018

(30) Foreign Application Priority Data
Apr. 13, 2018 (JP) 2018-077961

(51) Int. Cl. A23N 17/00; A23G 9/26

(52) U.S. Cl. CPC A23N 17/005; A23K 50/48; A23G 9/265

(57) ABSTRACT

Provided is an ice candy forming tool for pets which can form an ice candy simply and reliably, and the formed ice candy can be properly fed to pets. An ice candy forming tool for pets, which comprises an ice candy holding part comprising guard having first surface and second surface, grip which is connected to the first surface, and ice candy holding piece which is connected to the second surface, and a body part comprising concave portion and opening; wherein the guard has a notch which is provided on circumferential edge of the guard and communicates the first surface with the second surface.

### FIELD OF THE INVENTION

The present invention relates to an ice candy (including a frozen food) forming tool for pets which can form an ice candy simply and reliably, and the formed ice candy can be properly fed to pets.

### BACKGRAOUND ART

Generally, an ice candy is preferably eaten during a hot season like summer, and can present a taste of material and a cool feeling due to low temperature. Recently, there is an ice candy for pets such as a dog and a cat.

As a usual ice candy, there are one packed in a cup, and one held by a stick where a part of the stick is inserted thereto. Particularly, the latter case is employed in many cases, because the ice candy can be eaten or fed while changing the direction of the ice candy freely (for example, Patent Literature 1).

### PRIOR ARTS

### Patent Literature

Patent Literature 1: Japanese Patent Laid-Open Application 2011-217722

### SUMMARY OF THE INVENTION

### Problems to be solved by the invention

However, with respect to the conventional ice candy with the grip stick, it is difficult to hold the ice candy when feeding to pets. As in the case of Patent Literature 1, in order to improve the holding property if a guard for liquid drop 2 is provided near the grip part positioned at the lower portion of the stick, the ice candy at the bottom portion of the holding piece which is inserted into the ice candy (near the connecting portion to the guard for liquid drop 2) is remained, and it is difficult to feed all ice candy to the pets.

Further, the ice candy is so formed that a specified die is filled with a material and then the material is cooled. At that time, it is difficult to introduce an optimum amount to the die. Further, because the grip stick is inserted after filling with the material, the excess material overflows. When cooling the overflowed material as it is, there are troubles that a shape of the obtained ice candy is deformed, and that the frozen ice candy cannot be pulled out from the die.

The aspect of the present invention is to solve the above problems and to provide an ice candy forming tool for pets which can form and hold an ice candy simply and reliably, and further, the formed ice candy can be wholly fed to pets.

### Means for solving the problems

In order to solve the above problems, the present invention can provide an ice candy forming tool for pets, which comprises:

an ice candy holding part comprising a guard part having a first surface and a second surface, a grip part which is connected to the first surface, and an ice candy holding piece which is connected to the second surface, and

a body part comprising a concave portion having a depth longer than a length of the ice candy holding piece, and an opening having an area smaller than an area of the guard part;

wherein the guard part has a notch part which is provided on at least a part of a circumferential edge of the guard part and communicates the first surface with the second surface.

According to the ice candy forming tool for pets of the present invention having the above construction, an ice candy (including a frozen food) for feeding to pets such as a dog and a cat can be formed simply and reliably, and the formed ice candy can be properly fed to the pets. When forming the ice candy, even if the concave portion is filled with an excess amount of an ice candy material (fluid such as paste-like material or liquid material), the overflowed paste-like material can be stored or collected in a space, which acts as a pool or reservoir space, and is formed by the opening and the notch, and thus, the frozen ice candy can be easily pulled out from the concave portion, because the frozen overflowed material which may prevent the ice candy from the pulling out procedure is collected only within the restricted space formed by the notch and does not cover the guard part and the body part. Further, even if an amount of the overflowed material is excess to the volume of the space which is formed by the opening and the notch and then overflowed, since the area of the overflowed material is restricted to the limited and specified small area near the notch, the overflowed material can be easily removed by simple wiping.

Further, since the ice candy can be held reliably not only by the ice candy holding piece but also by the second surface of the guard part, even if the pet pushes the ice candy strongly during the feeding, the feeding person can continue the feeding of the ice candy reliably by operating the ice candy easily.

In the ice candy forming tool for pets of the present invention, it is preferable that the guard part has a plurality of the notch parts which are disposed at a predetermined distance (specifically, a plurality of the notch parts are provided along the circumferential edge of the guard part at an angle of 180 or 90 degrees around the center of the guard part).

According to the ice candy forming tool for pets of the present invention having the above construction, since the notches can be provided at a proper distance, and the overflowed material can be stored or collected in the notches in the properly dispersed manner, the ice candy having a good and well balanced shape can be formed and kept.

In the ice candy forming tool for pets of the present invention, it is preferable that the second surface is formed so as to project toward the ice candy forming piece in the convex manner.

According to the ice candy forming tool for pets of the present invention having the above construction, when the feeding is advanced and the ice candy remains only around the root of the ice candy holding piece, since the second surface of the guard part is formed in the convex manner, namely is a convex surface having a larger surface area than a flat surface, the pet can easily approach the root and eat the whole remaining ice candy easily and reliably.

In the ice candy forming tool for pets of the present invention, it is desirable that the concave portion further has deepest parts, and the ice candy holding piece is arranged so that the both edges of the ice candy holding piece face the deepest parts.

According to the ice candy forming tool for pets of the present invention having the above construction, in the ice candy holding part, the ice candy material remains in the deepest parts in a relatively large amount, and thus, after freezing, the ice candy can be formed and held at the both edges of the ice candy holding piece reliably.

In the ice candy forming tool for pets of the present invention, it is desirable that

a difference between the length of the ice candy holding piece and the depth of the concave portion of the body part is within the range of 3 mm to 15 mm.

According to the ice candy forming tool for pets of the present invention having the above construction, the ice candy holding piece can be inserted properly to hold the ice candy reliably by the ice candy holding part. Further, it is possible to feed easily depending to the depth of the mouth of the pets.

### Effects of the invention

When using the ice candy forming tool for pets of the present invention, it is possible to form and hold an ice candy for pets simply and reliably, and further the formed ice candy can be wholly fed to pets.

### BRIEF EXPLANATION OF DRAWINGS

FIG. 1 is a schematic view showing the summary of the ice candy forming tool 1 for pets according to the one embodiment of the present invention.

FIGS. 2A to 2C show the construction of the ice candy holding part 3 shown in FIG. 1, and FIG. 2A is a plan view of the ice candy holding part 3, FIG. 2B is a front view of the ice candy holding part 3, and FIG. 2C is a side view of the ice candy holding part 3.

FIGS. 3A to 3C show the construction of the body part 11 shown in FIG. 1, and FIG. 3A is a plan view of the body part 11, FIG. 3B is a front view of the body part 11, and FIG. 3C is a side view of the body part 11.

FIG. 4 is a schematic view showing the ice candy holding part 3 and the body part 11 which are engaged.

FIGS. 5A and 5B are explanation views for forming the ice candy 51 by using the ice candy forming tool for pets, and FIG. 5A is a schematic view showing the arrangement of the ice candy holding part, and FIG. 5B is a schematic view showing the method for engaging the ice candy holding part 3 with the body part 11.

FIGS. 6A and 6B show the effects of the notch 25 at the time of forming the ice candy 51, FIG. 6A is a sectional view showing the area near the opening 15 at the time of forming the ice candy 51 by using an ice candy forming tool for pets without the notch 25, and FIG. 6B is a sectional view showing the area near the opening 15 at the time of forming the ice candy 51 by using an ice candy forming tool 1 for pets with the notch 25.

### PREFERRED EMBODIMENTS

In the following, the ice candy forming tool for pets according to the typical embodiment of the present invention is explained in detail by referring the drawings. However, the present invention is not limited to these drawings, and because the drawings are used to explain the concept of the present invention, as occasion demand, there is a case where the ratio and number of the parts may be exaggerated or simplified for the sake of easy understanding. Further, in the following, there are cases that the same symbols may be applied to the same or corresponding parts, and overlapped explanation may be omitted.

### 1. Summary of the Ice Candy Forming Tool for Pets

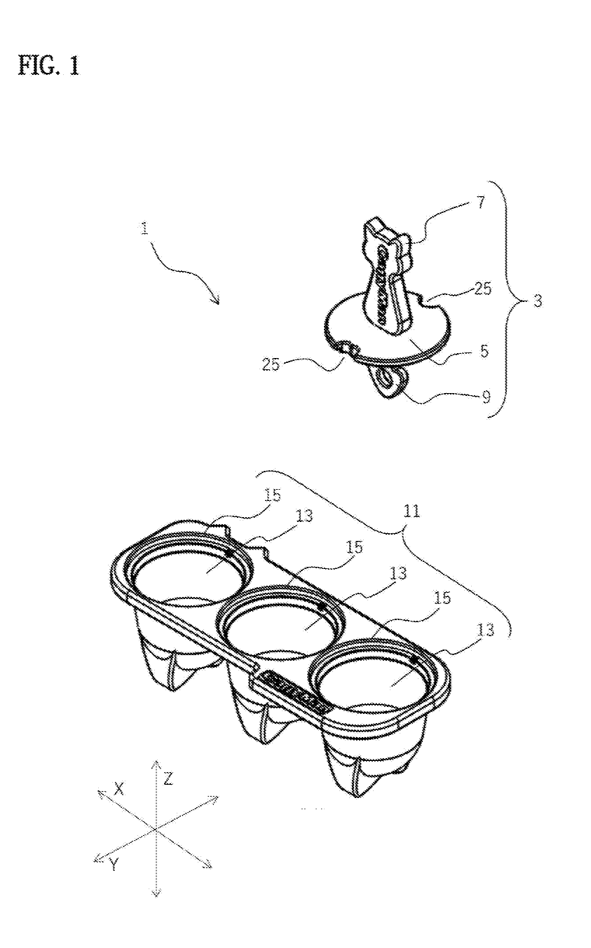

By referring to FIG. 1, the summary of the ice candy forming tool 1 for pets according to the present embodiment is explained. FIG. 1 is a schematic view showing the summary of the ice candy forming tool 1 for pets according to the present embodiment. In the present embodiment, for the sake of easy understanding, the direction X indicates the right-left direction, the direction Y indicates the front-back direction, and the direction Z indicates the up-down direction. The ice candy forming tool 1 for pets is to form and hold the ice candy 51 (including frozen food) for mainly dogs or cats simply and reliably, and further the formed ice candy can be properly fed to pets.

The ice candy forming tool 1 for pets has, as mentioned above, a function for holding the ice candy 51 and a function for feeding. In order to freeze the material of the ice candy for holding, the freezing treatment is carried out by using a separated freezer, or the like. The ice candy 51 may be a food such as a jelly which solidifies at a normal temperature.

### 2. Construction of the Ice Candy Forming Tool 1 for Pets

### <Construction of the Ice Candy Forming Tool 1 for Pets>

Next, the construction of the ice candy forming tool 1 for pets is explained in detail. As shown in FIG. 1, the ice candy forming tool 1 for pets is almost composed of two elements, that is the ice candy holding part 3 for holding the ice candy 51, and the body part 11 for forming the ice candy 51 into a desired shape and letting the ice candy holding part 3 hold the formed ice candy.

### <Construction of the Ice Candy Holding Part 3>

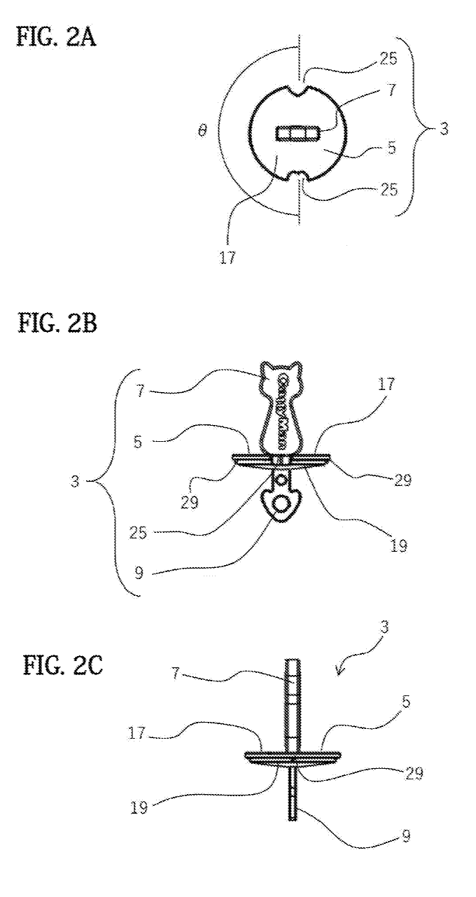

The construction of the ice candy holding part 3 is explained in detail by referring FIGS. 2A, 2B and 2C. FIGS. 2A, 2B and 2C show the construction of the ice candy holding part 3, and FIG. 2A is a plan view of the ice candy holding part 3, FIG. 2B is a front view of the ice candy holding part 3, and FIG. 2C is a side view of the ice candy holding part 3. The ice candy holding part 3 is the element for holding the ice candy 51 and for feeding the ice candy to the pets properly.

As shown in FIGS. 2A, 2B and 2C, the ice candy holding part 3 is almost composed of three elements, that is, a guard part 5 to support or hold the ice candy 51 by the surface, a grip part 7 which is gripped by a feeding person at the ice candy 51 forming step and the feeding operation, and an ice candy holding piece 9 to hold the ice candy 51 by inserting thereto and supporting the ice candy from the inside. It is preferable that the above three elements are integrally made of a resin which is low in low temperature brittleness to be the ice candy holding part 3.

The guard par 5 is a flat part having an approximately circular and flat shape, and has a first surface 17 on its one side, and a second surface 19 on its another side. The guard part 5 has two notches 25 which are provided on the circumferential edge (in other word, near an arc of the circumferential edge) of the guard part and communicates the first surface 17 with the second surface 19, and the two notches 25 are arranged at an angle of 180 degrees to each other around the center of the guard part 5 in the plan view (particularly, see FIG. 2A). Thereby, the notches 25 are arranged at a proper distance, and thus the overflowed material 53 of the ice candy 51 can be dispersed.

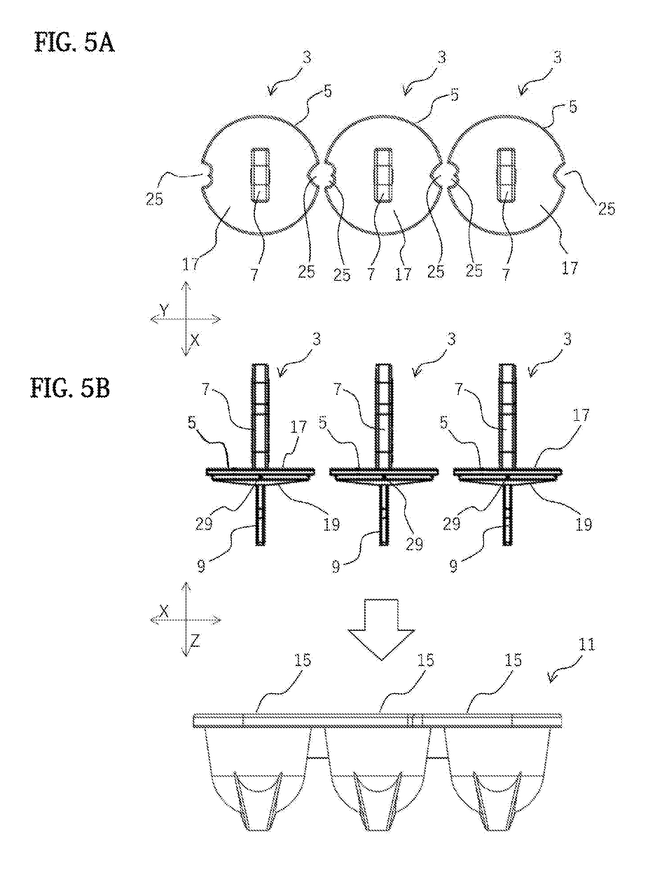

The notch 25 is so formed that the circumferential edge of the guard part is cut out toward the center of the guard part 5 in the plan view to a predetermined positon, and when the ice candy holding part 3 is engaged with the body part 11, the inside of the concave portion 13 of the body part 11 can be communicated with the outside. In the present embodiment, two or more guard parts 5 are aligned, and the notches 25 of the guard parts 5 of the ice candy holding parts 3 which are adjacent in the X direction are so arranged as to be closest, whereby the adjacent notches 25 form a desired mark (heart mark in the present embodiment) (see FIG. 5A).

Specifically, in this embodiment, the notches 25 are so formed that the desired mark is divided to two parts, and by arranging the two notches 25 closely, the desired mark is appeared (formed) again. According to this embodiment, there is a second effect that the design of the ice candy forming tool 1 for pets and the obtained ice candy 51 can be improved (detailed effects of the notch 25 is explained hereinafter).

The first surface 17 and the second surface 19 are, as mentioned above, provided in the up-down direction Z of the guard part 5 in the plan view from the grip part 7, and the first surface is almost flat and smooth, and the second surface 19 has convex and round surface which is projected toward the ice candy holding piece 9. The grip part 7 is connected to the first surface 17 side (upper side in the up-down direction Z), and the ice candy holding piece 9 is connected to the second surface 19 side (lower side in the up-down direction Z).

Since the first surface 17 is formed in the flat and smooth manner, at the feeding, the feeding person can grip the grip part 7 firmly in contact with the guard part 5, and thus can operate the ice candy 51 and the ice candy holding part 3 which supports the ice candy more stably. Accordingly, even when the pet moves violently during the feeding to attack the ice candy, the feeding person can keep the firm grip.

Since the second surface 19 is formed in the convex manner toward the ice candy holding piece 9, the ice candy 51 supported by the ice candy holding piece 9 can be held more reliably on the guard part due to the surface contact, in other words, since the convex surface increases in its surface area, the holding strength can be improved more. Further, when the feeding goes on and the ice candy 51 remains only near the root of the ice candy holding piece (near the second surface 19 side), it is possible to let the ice candy 51 position near the mouth of the pet due to the convex second surface 19, and thus, the feeding can be finished completely and easily.

The second surface 19 of the guard part 5 has a plurality of positioning projections 29, and by engaging with a positioning hole 31 mentioned below, the ice candy holding part 3 and the body part 11 can be properly positioned at a predetermined position.

The grip part 7 is a part to grip and operate the ice candy holding part 3 by the feeding person. In the present embodiment, the grip part is formed in the shape of almost stick having a predetermined length, and one end of the grip part is connected to the almost center of the first surface 17 of the guard part 5. As in the present embodiment, it is possible, by designing the surface and profile of the grip part 7 like a cat, to give visual interest to the pet, and to improve the feeding person's attachment (see FIG. 2B).

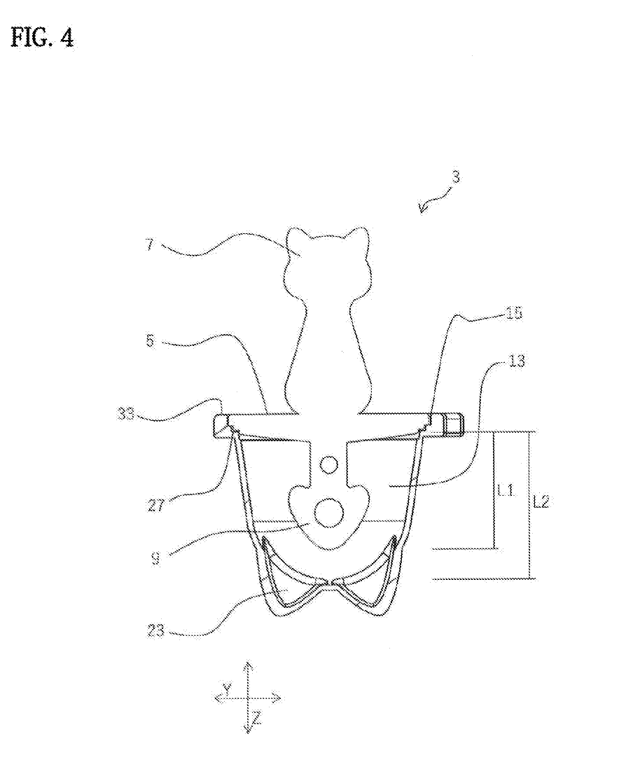

The ice candy holding piece 9 is a part to support or hold the ice candy 51 in the condition where being inserted into the ice candy 51, and in the present embodiment, is formed in the shape of almost flat stick having a predetermined length. One end of the ice candy holding piece is connected to the second surface 19 of the guard part 5. With respect to the ice candy holding piece 9, it is desirable that, in order to hold the ice candy 51 from the inside, for example, the profile of the holding piece is modified by providing projections (not shown) or pores to improve the bonding force (anchor effect) to the ice candy 51, for example a tail as shown in FIG. 2B and FIG. 4.

According to the ice candy holding part 3 having the above construction, the ice candy 51 can be held by the ice candy holding piece 9 and the second surface 19 of the guard part 5 reliably, and even when the pet attacks the ice candy 51, the feeding person can operate the ice candy 51 easily by controlling the guard part 5 and grip part 7.

### <Construction of the Body Part 11>

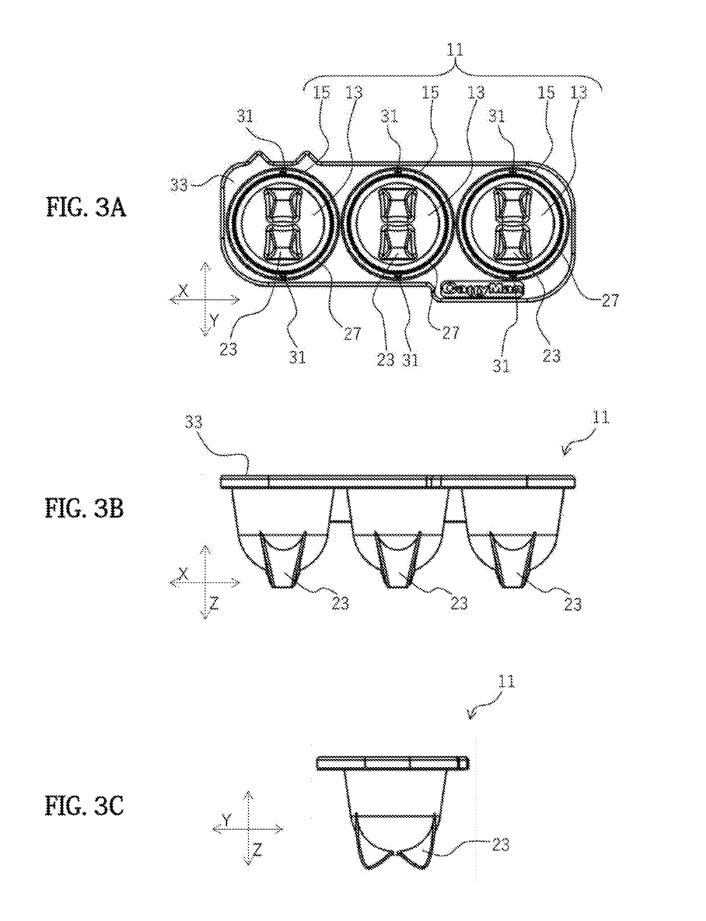

The construction of the body part 11 is explained in detail by referring FIGS. 3A, 3B and 3C. FIGS. 3A, 3B and 3C show the construction of the body part 11, and FIG. 3A is a plan view of the body part 11, FIG. 3B is a front view of the body part 11, and FIG. 3C is a side view of the body part 11. The body part 11 is a part to form the ice candy 51 of the desired shape by charging with a paste-like raw material of the ice candy 51.

As shown in FIGS. 3A, 3B and 3C, the body part 11 is almost composed of a concave portion 13 where a raw material of the ice candy 51 is filled with, and an opening 15 which is provided upward of the concave portion 13 in the up-down direction Z and communicates the inside of the concave portion 13 and the outside. It is preferable that the body part 11 is made of a resin which is low in low temperature brittleness. In the present embodiment, a plurality of sets of the concave portion 13 and the opening 15 are provided in the right-left direction X in order to form a plurality of the ice candies 51 at the same time, but the present invention is not limited to this embodiment, one set of the concave portion 13 and the opening 15 may also be usable.

The concave portion 13 is a part of an almost cup-shape having a depth L2 from the opening 15 to the bottom in the up-down direction Z, and has the deepest parts 23 in its bottom portion which are far deep (particularly see FIG. 3A and FIG. 4). When providing the deepest parts 23 are provided in bottom part of the concave portion 13, it is possible to arrange in the manner that the both edges of the ice candy holding piece 9 face to the deepest parts 23 to form and hold the ice candy 51. In this manner, the deepest parts 23 are filled with a relatively large amount of the raw material of the ice candy 51 from the viewpoint of the ice candy holding part 3, and thus the ice candy 51 can be formed and held at the both edges of the ice candy holding piece 9.

The opening 15 is a part to communicate the inside of the concave portion 13 and the outside upward of the concave portion 13 in the up-down direction Z. The concave portion 13 is filled with the raw material of the ice candy 51 from the opening 15, and by freezing under the condition where the ice candy holding piece 9 of the ice candy holding part 3 is inserted, the ice candy 51 can be formed.

In addition, near the opening 15, there is provided an engaging part 27 which is composed of a plurality of steps to engage with the guard part 5 of the ice candy holding part 3 and temporarily fix the ice candy holding part on the body part. Further, in a part of the engaging part 27, the positioning hole 31 which is engaged with the positioning projection 29 is provided.

According to the present embodiment, as mentioned above, three sets composed of the concave portion 13 and the opening 15 are arranges in the right-left direction X, and the sets are connected by an edge part 33 which connects integrally the peripheral portions of the openings 15, which can form a plurality of the ice candies 51 at the same time. The number of the sets to be connected may be optionally adjusted due to the size of freezer.

### <Situation of Engagement of the Ice Candy Holding Part 3 and the Body Part 3>

The situation of engagement of the ice candy holding part 3 and the body part 3 is shown in FIG. 4. FIG. 4 is a schematic view showing one unit of the engaged state of the ice candy holding part 3 and the body part 3. The ice candy holding piece 9 of the ice candy holding part 3 is inserted into the concave portion 13 of the body part 11, and the edge of the second surface 19 of the guard part 5 is engaged with the engaging part 27 of the opening 15 (the engagement of the positioning projection 29 and the positioning hole 31 is also achieved at the same time). This is the manner of forming the ice candy 51 by using the ice candy forming tool 1 for pets according to the present embodiment.

In the above situation, it is desirable that a difference between the length L1 of the ice candy holding piece 9 and the depth L2 of the concave portion 13 of the body part 11 (a distance from the neighboring of the second surface 19 to the bottom of the concave portion 13), in other word, a distance or gap between the bottom of the body part 11 and the top of the ice candy holding piece 9 is within the range of about 3 mm to 15 mm. When the distance is within the above range, the ice candy holding piece 9 is inserted properly into the ice candy 51, the ice candy 51 can be held reliably by the ice candy holding part 3. Further, it is possible to control the feeding easily depending to the depth of the mouth of the pet.

### 3. Method of Use of the Ice Candy Forming Tool 1 for Pets

### <Forming the Ice Candy 51 by Using the Ice Candy Forming Tool 1 for Pets>

By referring FIGS. 5A and 5B, the formation of the ice candy 51 by using the ice candy forming tool 1 for pets is explained in detail. FIGS. 5A and 5B are explanation views for forming the ice candy 51 by using the ice candy forming tool 1 for pets, and FIG. 5A is a schematic view showing the arrangement of the ice candy holding part, and FIG. 5B is a schematic view showing the method for engaging the ice candy holding part 3 with the body part 11.

In the present embodiment, as mentioned above, since the body part 11 has three sets of the concave portion 13 and the opening 15 which are arranged in the right-left direction X, corresponding three ice candy holding parts 3 are used for forming the ice candy 51.Firstly, the concave portion 13 of the body part 11 is filled with the paste-like raw material of the ice candy 51 in a proper amount, and then the ice candy holding piece 9 of the ice candy holding part 3 is inserted to each concave portion.

More specifically, after each concave portion 13 is filled with the raw material of the ice candy 51, the ice candy holding piece 9 is inserted to corresponding concave portion 13 in turn, and at that time, while inserting the ice candy holding piece 9 to the concave portion 13, the positioning projection 29 of the guard part 5 and the positioning hole 31 of the opening 15 are positioned to engage the ice candy holding part 3 to the body part 11.

After engaging the first set of the ice candy holding part 3 and the body part 11 according to the above procedures, the following ice candy holding part 3 is set so that the notch 25 of the own guard part 5 is positioned to the notch 25 of the guard part 5 of the ice candy holding part 3 which is adjacent in the right-left direction X (arrangement so that both notches 25 are faces to each other), which not only gives a proper positioning of the ice candy holding part 3 relative to each concave portion 13 simply, but also provides a larger space of reservoir or pool for overflowed material.

After the completion of the all above procedures, by entering the ice candy forming tool 1 for pets where the paste-like raw material in a freezer for a predetermine period of time, the formation of the ice candy 51 can be completed by using the ice candy forming tool 1 for pets. After the completion of the freezing of the ice candy 51, when the ice candy holding part 3 is pulled out from the concave portion 13 of the body part 11 upward in the up-down direction Z, the ice candy 51 can be ready to feed in the manner where the ice candy 51 is held by the ice candy holding part 3.

### <Effect of the Notch 25>

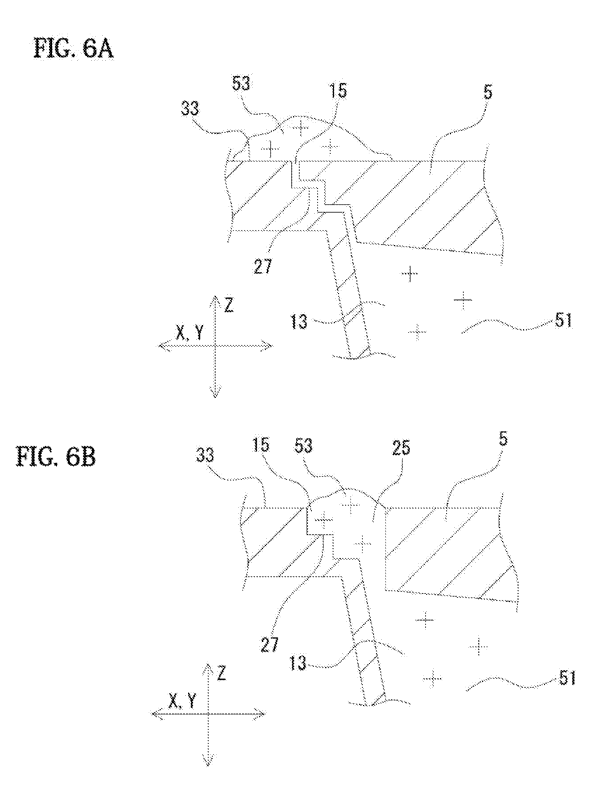

By referring FIGS. 6A and 6B, the effect of the notch 25 of the guard part 5 at the time of forming the ice candy 51 is explained in detail. FIGS. 6A and 6B show the effect of the notch 25 at the time of forming the ice candy 51, FIG. 6A is a sectional view showing the area near the opening 15 at the time of forming the ice candy 51 by using an ice candy forming tool for pets without the notch 25, and FIG. 6B is a sectional view showing the area near the opening 15 at the time of forming the ice candy 51 by using an ice candy forming tool 1 for pets with the notch 25.

According to the ice candy forming tool 1 for pets, since the guard part 5 has the aforementioned notch 25, even when the concave portion 13 is filled with an excess amount of raw material at the time of forming the ice candy 51, it is possible to regulate easily to the proper amount of raw material, and if overflowed, the treatment is simple and easy.

More specifically, in the aforementioned ice candy forming procedures, at the time when the raw material is introduced into the concave portion 13, usually the concave portion 13 is filled up to the opening 15, but since an operator usually regulates the amount with naked eyes, there happens every time and inevitably that the introduced amounts are uneven. In addition, since the ice candy holding piece 9 is inserted into the concave portion 13 after introducing the raw material into the concave portion, the introduced amount increases by the volume of the ice candy holding piece 9, which results in overflow of the raw material.

Therefore, it is difficult to regulate the amount of raw material to be introduced to the concave portion 13. Further, when the ice candy holding piece 9 is inserted in the concave portion 13 completely and the ice candy holding part 3 is engaged with the body part 11, if the raw material overflows beyond the opening 15, and the overflowed material is frozen to form an overflowed portion 53 under the condition where the overflowed material covers both of the edge part 33 of the body part 11 and the guard part 5, it is difficult to pull out the frozen ice candy 51 from the body part 11 (see FIG. 6A).

However, according to the ice candy forming tool 1 for pets of the present embodiment, as shown in FIG. 6B, since the notch 25 is provided in the guard part 5, even if the ice candy holding part 3 is engaged with the body part 11 in the manner where the concave portion 13 is filled with an excess amount of the raw material, the overflowed material, i.e. overflowed portion 53 can be retained within the space formed by the opening 15 and the notch 25, which can make the pulling out procedure of the ice candy 51 easy. Further, even if the excess amount of the raw material floods the space formed by the opening 15 and the notch 25 and goes to the outside, since the area is restricted near the notch 25, it is possible to remove easily by wiping. As a person skilled in the art can be well understood from the description and the drawings, the presence of the space formed by the opening 15 and the notch 25 can save the raw material, which contributes the decrease of the food loss.

In the above, the embodiments of the present invention are explained by referring the drawings, but the present invention is not limited thereto, and there are other improvements and modifications can be obtained without departing from the spirit and teaching. Those skilled in the art easily understand that those improvements and modifications are wholly included within the scope of the present invention.
5 guard part
7 grip part
9 ice candy holding piece
11 body part
13 concave portion
15 opening
17 first surface
19 second surface
23 deepest parts
25 notch
27 engaging part
29 positioning projection
31 positioning hole
33 edge part
51 ice candy
53 overflowed material
L1 length
L2 depth
θ angle

1. An ice candy forming tool for pets, which comprises:
an ice candy holding part comprising a guard part having a first surface and a second surface, a grip part which is connected to the first surface, and an ice candy holding piece which is connected to the second surface, and
a body part comprising a concave portion having a depth longer than a length of the ice candy holding piece, and an opening having an area smaller than an area of the guard part;
wherein the guard part has a notch part which is provided on at least a part of a circumferential edge of the guard part and communicates the first surface with the second surface.

2. The ice candy forming tool for pets according to claim 1, wherein
the guard part has a plurality of the notch parts which are disposed at a predetermined distance.

3. The ice candy forming tool for pets according to claim 1, wherein
the second surface is formed so as to project toward the ice candy forming piece in the convex manner.

4. The ice candy forming tool for pets according to claim 1, wherein
the concave portion further has deepest parts, and
the ice candy holding piece is arranged so that the both edges of the ice candy holding piece face the deepest parts.

5. The ice candy forming tool for pets according to claim 1, wherein
a difference between the length of the ice candy holding piece and the depth of the concave portion of the body part is within the range of 3 mm to 15 mm.
